(19) United States
(12) Patent Application Publication
(10) Pub. No.: US 2024/0037421 A1
(43) Pub. Date: Feb. 1, 2024

(54) SYSTEMS AND METHODS FOR KNOWLEDGE DISCOVERY FROM DATA AND PRIOR KNOWLEDGE

(71) Applicant: George Mason University, Fairfax, VA (US)

(72) Inventor: Gheorghe Tecuci, Fairfax, VA (US)

(21) Appl. No.: 18/227,443

(22) Filed: Jul. 28, 2023

Related U.S. Application Data
(60) Provisional application No. 63/393,330, filed on Jul. 29, 2022.

(51) Int. Cl. G06N 5/022

(52) U.S. Cl. CPC G06N 5/022

(57) ABSTRACT

A system for knowledge discovery includes a processor and a memory. The memory includes instructions which, when executed by the processor, cause the system to: access a reference case of a plurality of cases; generate argumentation explaining a phenomenon of the reference case by developing a predictive model; generate a knowledge-based generalization of the argumentation; apply the argumentation to a plurality of cases similar to the reference case based on knowledge-based search and classification; split the plurality of similar cases into a plurality of favoring cases and a plurality of disfavoring cases; select a disfavoring case based on a similarity of factors; determine what factors were not taken into account in generating the argumentation; and generate a hypothesis-driven explanation theory based on comparing one or more features of the reference case to one or more features of the most disfavoring case.

### CROSS-REFERENCE TO RELATED APPLICATION

This application claims the benefit of, and priority to, U.S. Provisional Patent Application No. 63/393,330 filed on Jul. 29, 2022, the entire contents of which are hereby incorporated herein by reference.

### TECHNICAL FIELD

The present application generally relates to knowledge discovery from existing data and prior knowledge, and more particularly, to utilize a Knowledge Discovery Assistant (KDA) to enable such discovery.

### BACKGROUND

Knowledge discovery from data (KDD), also known as Data Mining, is an area of scientific investigation that focuses on the development and application of methods such as classification, clustering, and association rule mining, to discover information from large collections of data streams. These processes identify valid, novel, and understandable relationships within a data set.

The use of KDD and machine learning is largely driven by applied problems in science and technology. The existing approaches to KDD are heavily based on statistical machine learning (SML). SML involves the use of statistical techniques to develop models that can learn from data streams and make predictions. This method of machine learning relies on statistics and learns single functions from a large number of examples. There are various areas of learning that do not require features to be discovered through statistical comparison of a large number of positive and negative examples, as required by SML methods. Thus, for fields of learning that do not utilize large number of examples, the SML, approach is not useful because SML, requires the creation of data sets with large numbers of examples which is both timely and costly.

### SUMMARY

In accordance with aspects of the present disclosure, a system for knowledge discovery includes a processor and a memory coupled to the processor. The memory stores instructions which, when executed by the processor, cause the system to: access a reference case of a plurality of cases; generate argumentation that explains a phenomenon of the reference case by developing a predictive model; generate a knowledge-based generalization of the argumentation by learning a lower bound generalization and an upper bound generalization; apply the argumentation to a plurality of cases similar to the reference case based on knowledge-based search and classification; split the plurality of similar cases into a plurality of favoring cases and a plurality of disfavoring cases; select a disfavoring case of the plurality of disfavoring cases that is most similar to the reference case based on a similarity of factors; determine what factors were not taken into account in generating the argumentation; and generate a hypothesis-driven explanation theory based on comparing one or more features of the reference case to one or more features of the most disfavoring case.

In an aspect of the present disclosure, when generating a knowledge-based generalization of the argumentation, the instructions, when executed by the processor, may further cause the system to: learn an evidence collection rule for each argument that reduces the hypothesis to an evidence item; and search the plurality of reference cases, by a collection agent, for the evidence item.

In yet another aspect of the present disclosure, the predictive model may include a probabilistic inference network.

In an aspect of the present disclosure, the predictive model may include a Wigmorean probabilistic inference network.

In an aspect of the present disclosure, the argumentation may include at least one of a hypothesis or a conjunction of sub hypothesis.

In another aspect of the present disclosure, the hypothesis to be assessed may be decomposed into simpler hypotheses by considering both favoring arguments and disfavoring arguments.

In yet another aspect of the present disclosure, the lower bound may employ a cautious learner strategy. The upper bound may employ an aggressive learning strategy.

In a further aspect of the present disclosure, the disfavoring case may provide an indication that the generated argumentation is incomplete and/or partially incorrect.

In yet a further aspect of the present disclosure, the instructions, when executed by the processor, may further cause the system to refine the generated hypothesis-driven explanation theory based on selecting a new case from the plurality of disfavoring cases that is most similar to the reference case.

In accordance with aspects of the present disclosure, a system for determining cover crop biomass includes a processor and a memory. The memory is coupled to the processor and stores instructions which, when executed by the processor, cause the system to: select a reference farm case from a plurality of reference farm cases; access partial knowledge related to a phenomenon of the reference farm case; access imperfect data related to the phenomenon of the reference farm case; generate a predictive model based on the partial knowledge and imperfect data; predict a result related to the phenomenon of the reference farm case based on one or more features of the reference farm case; access actual results related to the phenomenon of the reference farm case; and generate a hypothesis-driven explanation theory that explains the phenomenon based on comparing the predicted result to the actual result.

In another aspect of the present disclosure, the predictive model may include a Wigmorean probabilistic inference network.

In accordance with aspects of the present disclosure, a computer-implemented method for knowledge discovery includes: selecting a reference case of a plurality of reference cases; generating argumentation that explains a phenomenon of the reference case by developing a predictive model; generating a knowledge-based generalization of the argumentation by learning a lower bound and an upper bound; applying the argumentation to a plurality of similar cases that to the reference case based on knowledge-based search and classification; splitting the plurality of similar cases into a plurality of favoring cases and a plurality of disfavoring cases; selecting the most disfavoring case of the plurality of disfavoring cases based on a similarity of factors to the most disfavoring case; determining what factors were not taken into account in generating the argumentation; and generating a hypothesis-driven explanation theory based on comparing one or more features of the reference case to one or more features of the most disfavoring case.

In an aspect of the present disclosure, when generating a knowledge-based generalization of the argumentation, the method may further include: learning an evidence collection rule for each argument that reduces the hypothesis to an evidence item; and searching the plurality of reference cases, by a collection agent, for the evidence item.

In accordance with aspects of the present disclosure, the predictive model may include a Wigmorean probabilistic inference network.

In an aspect of the present disclosure, the argumentation may include at least one of a hypothesis or a conjunction of sub hypothesis.

In another aspect of the present disclosure, the hypothesis to be assessed may be decomposed into simpler hypotheses by considering both favoring arguments and disfavoring arguments.

In yet another aspect of the present disclosure, the lower bound may employ a cautious learner strategy. The upper bound may employ an aggressive learning strategy.

In a further aspect of the present disclosure, the disfavoring case may provide an indication that the generated argumentation is incomplete and/or partially incorrect.

In yet a further aspect of the present disclosure, the method may further include refining the generated hypothesis-driven explanation theory based on selecting a new case from the plurality of disfavoring cases that is most similar to the reference case.

In yet another aspect of the present disclosure, the predictive model may include probabilistic inference network.

Further details and aspects of exemplary embodiments of the present disclosure are described in more detail below with reference to the appended figures.

### BRIEF DESCRIPTION OF THE DRAWINGS

A better understanding of the features and advantages of the disclosed technology will be obtained by reference to the following detailed description that sets forth illustrative embodiments, in which the principles of the technology are utilized, and the accompanying drawings of which:

FIG. 1 is a flow diagram illustrating an exemplary system for knowledge discovery from data and prior knowledge, in accordance with aspects of the present disclosure;

FIG. 2 is a block diagram of a controller of the system of FIG. 1, in accordance with aspects of the present disclosure;

FIG. 3 is a more detailed flow diagram of the system of FIG. 1 in accordance with aspects of the present disclosure;

FIG. 4 is an example diagram of the partial knowledge of the system of FIG. 1, in accordance with the present disclosure;

FIG. 5 is a diagram illustrating a Wigmorean probabilistic inference network of the system of FIG. 1, in accordance with the present disclosure;

FIGS. 6A and 6B is an example Wigmorean probabilistic inference network and the corresponding ontology fragment of the system of FIG. 1, in accordance with the present disclosure;

FIGS. 7A and 7B is a diagram that illustrates example rules learned from the argumentation of FIGS. 6A and 6B, in accordance with the present disclosure;

FIG. 8 is a diagram illustrating argumentation generated by the system of FIG. 1 that is inconsistent with example evidence, in accordance with the present disclosure;

FIG. 9 is a diagram illustrating an example refined argument generated by the system of FIG. 1, in accordance with the present disclosure;

FIGS. 10A and 10B are a diagram illustrating the argumentation generated by the system of FIG. 1 that is inconsistent with example evidence (left) and the refined argument generated by the system of FIG. 1 (right), in accordance with the present disclosure;

FIGS. 11A and 11B are example comparisons of cover crop application in a field before and after termination of the cover crop, in accordance with the present disclosure;

FIG. 12 is a diagram illustrating the causal relationships between different factors and the germination, emergence, and growth of weeds, in accordance with the present disclosure;

FIG. 13 is a diagram illustrating an ontological representation of the system of FIG. 1, in accordance with the present disclosure;

FIG. 14A is an example illustrating an example Wigmorean probabilistic inference network and probability scale for a specific farm, in accordance with the present disclosure;

FIG. 14B is an example illustrating an example Wigmorean probabilistic inference network for the prior year of the farm of FIG. 14A, in accordance with the present disclosure;

FIG. 14C is an example illustrating a refinement of the Wigmorean probabilistic inference network of FIG. 14A, in accordance with the present disclosure;

FIG. 15 is an example illustrating an explanation-based refinement of the example Wigmorean probabilistic inference network, in accordance with the present disclosure;

FIG. 16 is an example description of an example Wigmorean probabilistic inference network, in accordance with the present disclosure;

FIG. 17 is an example of the use of the predictive model of the system of FIG. 1 for predicting behaviors, in accordance with the present disclosure; and

FIG. 18 is an example of the use of the predictive model of the system of FIG. 1 for predicting behaviors, in accordance with the present disclosure.

### DETAILED DESCRIPTION

The present application relates to systems and methods for knowledge discovery from data and prior knowledge.

For purposes of promoting an understanding of the principles of the present disclosure, reference will now be made to exemplary embodiments illustrated in the drawings, and specific language will be used to describe the same. It will nevertheless be understood that no limitation of the scope of the present disclosure is thereby intended. Various alterations, rearrangements, substitutions, and modifications of the inventive features illustrated herein, and any additional applications of the principles of the present disclosure as illustrated herein, which would occur to one skilled in the relevant art and having possession of this disclosure, are to be considered within the scope of the present disclosure.

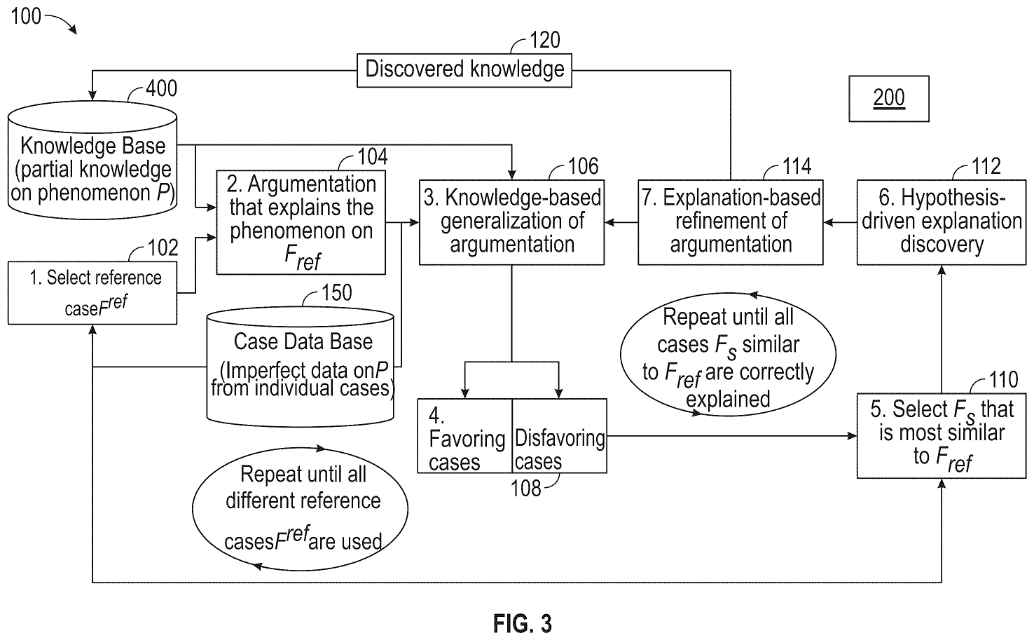

Referring to FIG. 3, an exemplary system 100 for knowledge discovery from data and prior knowledge includes a controller 200 (FIG. 2). It is contemplated that the controller 200 may run programs locally on the controller 200, remotely via a network, over the cloud, and/or on a remote server. The controller 200 may include, but is not limited to, a mobile phone, a personal computer, a tablet, and/or other handheld device.

The network may be wired or wireless and can utilize technologies such as Wi-Fi®, Ethernet, Internet Protocol, 3G, 4G, 5G, TDMA, CDMA, or other communication technologies. The network may include, for example, but is not limited to, a cellular network, residential broadband, satellite communications, private network, the Internet, local area network, wide area network, storage area network, campus area network, personal area network, or metropolitan area network.

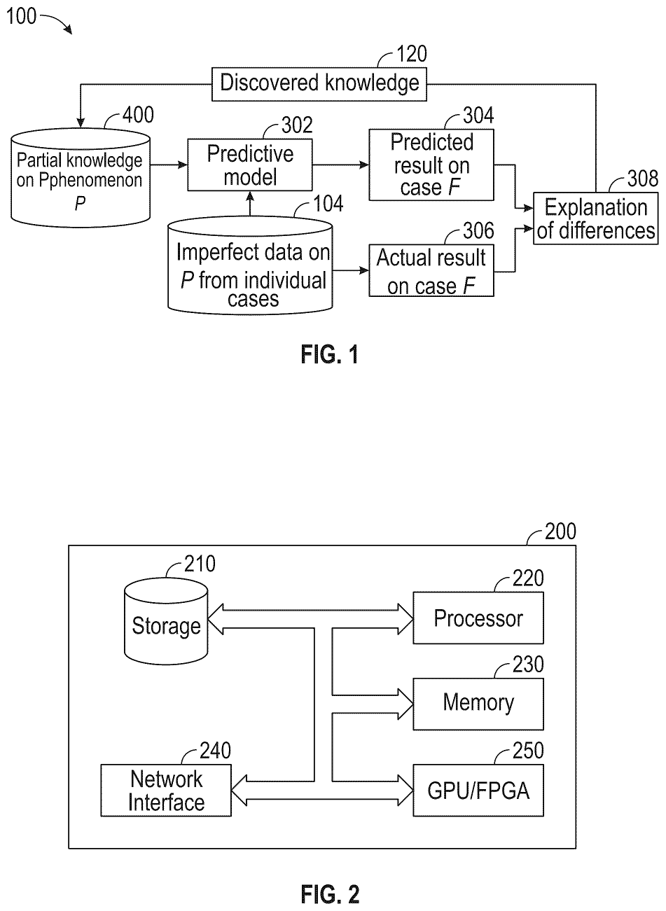

The term “application” may include a computer program and/or machine-readable instructions designed to perform particular functions, tasks, or activities for the benefit of a user. Application may refer to, for example, software running locally or remotely, as a standalone program or in a web browser, or other software that would be understood by one skilled in the art to be an application. An application may run on the controller 200, a server, or on a user device, including, for example, on a user device or a client computer system. The configuration of FIG. 1 is exemplary, and variations are contemplated to be within the scope of the present disclosure.

FIG. 1 shows a flow chart for an exemplary use of the system for knowledge discovery from data and prior knowledge. Although the steps of FIG. 1 are shown in a particular order, the steps need not all be performed in the specified order, and certain steps can be performed in another order. For example, FIG. 1 will be described below, with a server (e.g., controller 200 of FIG. 2) performing the operations. In various aspects, the operations of FIG. 1 may be performed all or in part by the controller 200 of FIG. 1. In aspects, the operations of FIG. 1 may be performed all or in part by another device, for example, a mobile device and/or a client computer system. These and other variations are contemplated to be within the scope of the present disclosure.

The role of cover crops in weed suppression is complex and dependent on many factors, including geographical region, climate, and soil. Past research has shown that cover crop mulch levels are highly correlated with suppression of summer annual weeds. However, this relationship varies considerably with climate and soil type, and other plant-soil interactions. To date, there has not been an integration of these factors to elucidate how climate, soil, and management intersect to drive weed suppression. The incomplete understanding of the factors influencing weed growth stymies the ability to parameterize models that capture the complexity of cover crop-weed interactions. For example, the disclosed technology improves the current understanding of how climate, soil, and weed seed bank size interact with cover crop biomass to drive weed suppression.

In the past two decades, fungicide use on field crops has increased considerably. Several factors have been suggested for this growth in fungicide use, for example, increased commodity prices, more fungicide products registered for use on field crops, greater disease prevalence, and marketing. Fungicides have traditionally been applied to reduce disease, however, in more recent years they have been applied for their physiological plant effects that may contribute to yield increases. Research in soybean and other crops, however, indicates these physiological effects are inconsistent or do not always result in a measurable yield increase.

An understanding of the abiotic and biotic, management, and environmental factors that contribute to greater yields in field crops is needed to identify situations where an application of a fungicide could result in greater yields and returns on investment.

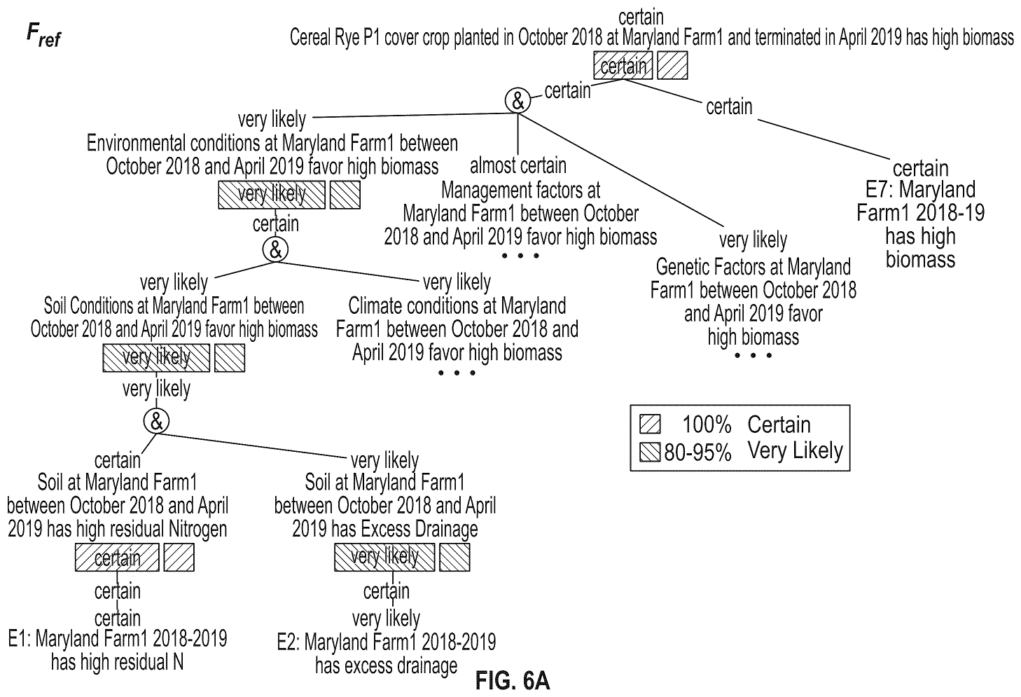

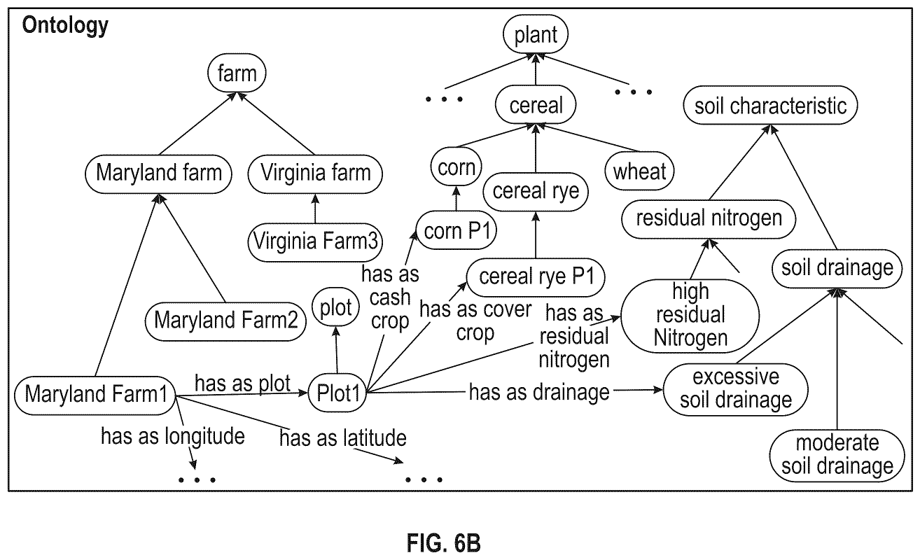

Initially, at step 302, the controller 200 causes the system 100 to start the discovery process with F_{ref} and generate a predictive model based on partial knowledge on phenomenon (P) and imperfect data on P from individual farms. In aspects, the predictive model may be in the form of a Wigmorean probabilistic inference network. For example, F_{ref} is Maryland Farm1 during the 2018-2019 cover crop season, a past case in which the cover crops produced high biomass (FIGS. 6A and 6B).

At step 304, the controller 200 causes the system 100 to predict the results for farm F.

At step 306, the controller 200 causes the system 100 to access the actual results of farm F.

At step 308, the controller 200 causes the system 100 to generate an explanation of the differences between the predicted results and the actual results for farm F.

Referring now to FIG. 2, exemplary components in the controller 200 in accordance with aspects of the present disclosure include, for example, a knowledgebase 210, one or more processors 220, at least one memory 230, and a network interface 240. In aspects, the controller 200 may include a graphical processing unit (GPU) 250, which may be used for processing machine learning models.

The database 210 can be located in storage. The term “storage” may refer to any device or material from which information may be capable of being accessed, reproduced, and/or held in an electromagnetic or optical form for access by a computer processor. Storage may be, for example, volatile memory such as RAM, non-volatile memory, which permanently holds digital data until purposely erased, such as flash memory, magnetic devices such as hard disk drives, and optical media such as a CD, DVD, Blu-ray disc, or the like.

In various embodiments, data may be stored on the controller 200, including, for example, user preferences, historical data, and/or other data. The knowledge can be stored in the knowledgebase 210 and sent via the system bus to the processor 220.

As will be described in more detail later herein, the processor 220 executes various processes based on instructions that can be stored in the server memory 230 and utilizing the knowledge from the knowledgebase 210. With reference also to FIG. 1, a request from a user device, such as a mobile device or a client computer, can be communicated to the server through the server's network interface 240. The illustration of FIG. 2 is exemplary, and persons skilled in the art will be understood other components that may exist in a controller 200. Such other components are not illustrated in FIG. 2 for clarity of illustration.

FIG. 3 shows a flow chart for an exemplary use of the system for knowledge discovery from data and prior knowledge. Although the steps of FIG. 3 are shown in a particular order, the steps need not all be performed in the specified order, and certain steps can be performed in another order. For example, FIG. 3 will be described below, with a server (e.g., controller 200 of FIG. 2) performing the operations. In various aspects, the operations of FIG. 3 may be performed all or in part by the controller 200 of FIG. 3. In aspects, the operations of FIG. 3 may be performed all or in part by another device, for example, a mobile device and/or a client computer system. These and other variations are contemplated to be within the scope of the present disclosure.

The disclosed technology improves a partial understanding of how some domain variables influence other domain variables. Initially, at step 102, the controller 200 causes the system 100 to select a reference case for which actual data about these variables exist.

At step 104, the controller 200 causes the system 100 to use current knowledge 400 to generate a predictive model 302 (FIG. 1). The predictive model 302 may be in the form of a probabilistic inference network that is configured to explain how the values of some variables from the reference case determine the values of other variables. A probabilistic inference network is a type of machine learning network. Examples of probabilistic inference networks include Bayesian network and/or a Wigmorean probabilistic inference network. These networks are directed acyclic graphs, consisting of nodes, representing relevant hypotheses, items of evidence, and unobserved variables, and/or arcs (and/or arrows) joining some of the nodes, representing dependency relations among them.

At steps 106, 108, 110, 112, and 114 the controller 200 causes the system 100 to iteratively and automatically apply the predictive model to other cases for which individual data exist, to identify cases where the predicted results differed from the actual results.

At step 112, the controller 200 causes the system 100 to generate an explanation of the differences between the reference case and these other cases stored in the database, leading to the discovery of new knowledge and the iterative improvement of the predictive model.

Unlike the existing knowledge discovery from data (KDD) approaches that rely on large amounts of data to draw conclusions, the disclosed technology can work with a few studies to formulate hypotheses that could explain the observed phenomenon and then test these hypotheses on the remaining studies. The disclosed technology enables the ability to efficiently work with massive amounts of data as well.

The disclosed technology provides a benefit in that the individual study data does not need to be complete or uniform because the individual study data is treated as evidence on the considered hypotheses, evidence that can be incomplete, inconclusive, ambiguous, dissonant, or have various degrees of accuracy.

A further benefit of the disclosed technology is that new experiments are not required (that may be expensive and may require significant time and effort) because the formulated hypotheses can be tested on existing data.

Although crop cover will be used as an example to assist in the understanding of the disclosed technology, other uses are contemplated.

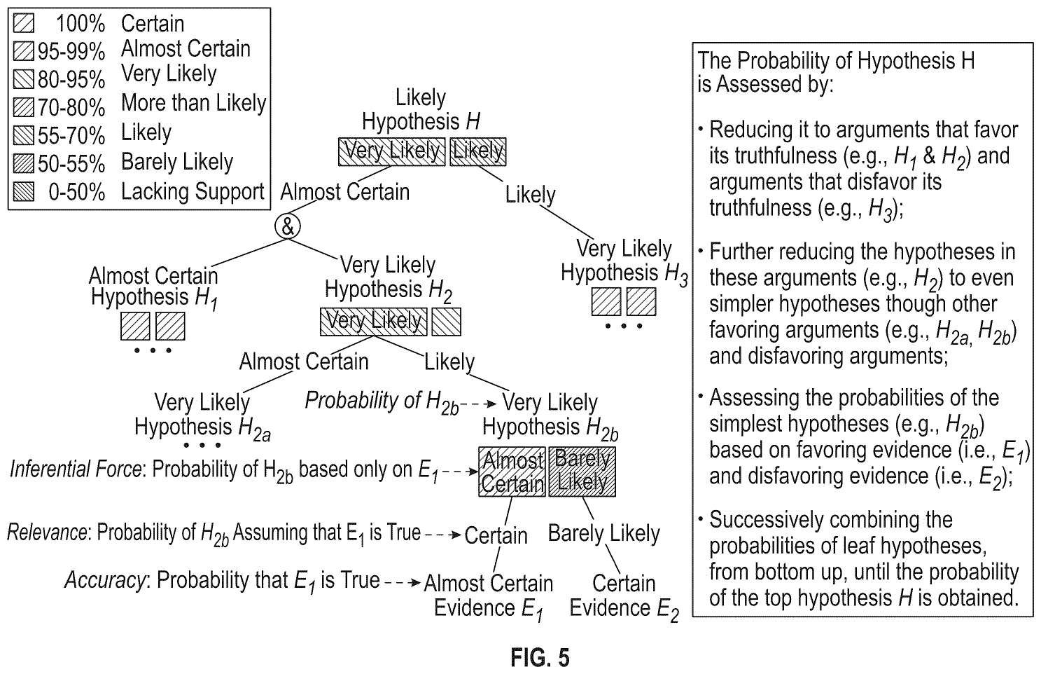

At step 102, the controller 200 causes the system 100 to select a reference case. For example, a reference farm case (F_{ref}) is selected that will guide the discovery of knowledge applicable to the class of cases similar to it. For example, F_{ref} is Maryland Farm1 during the 2018-2019 cover crop season, a past case in which the cover crops produced high biomass (FIG. 5).

At step 104, the controller 200 causes the system 100 to use the current knowledge 400 to develop a predictive model. The predictive model may be in the form of a Wigmorean probabilistic inference network (FIGS. 6A and 6B). For example, current cover crop knowledge may be used that explains how the various intrinsic and extrinsic factors supported the production of high cover crop biomass in the reference case F_{ref}.

At step 106, the controller 200 causes the system 100 to generate a knowledge-based generalization of the argumentation (FIGS. 6A and 6B). In aspects, the knowledge-based generalization may be performed by learning a lower bound and an upper bound. The lower bound may employ a cautious learner strategy and the upper bound may employ an aggressive learning strategy. For example, the controller 200 may cause the system 100 to learn an evidence collection rule for each argument that reduces the hypothesis to an evidence item and search the plurality of reference cases, by a collection agent, for the evidence item.

At step 108, the controller 200 causes the system 100 to discover favoring and disfavoring cases. For example, the controller 200 may cause the system 100 to split the plurality of similar cases into favoring cases and disfavoring cases. The disfavoring case may indicate that the generated argumentation is incomplete and/or partially incorrect.

At step 110, the controller 200 causes the system 100 to select the most disfavored case. For example, the controller 200 may cause the system 100 to select the most disfavoring case of the plurality of cases based on a similarity of factors to the most disfavoring case.

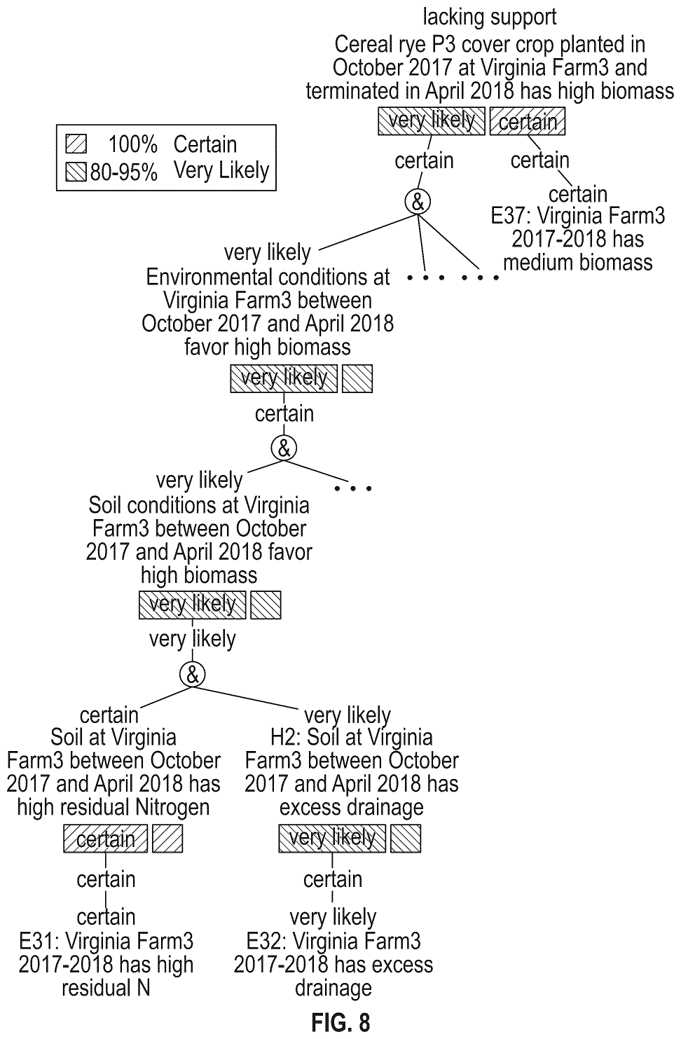

At step 112, the controller 200 causes the system 100 to determine what factors were not taken into account in generating the argumentation and improve the argumentation based on selecting a new case from the set of disfavoring cases that is most similar to the reference case (FIG. 8).

At step 114, the controller 200 causes the system 100 to perform explanation-based refinements of the argumentation. For example, the controller 200 may cause the system 100 to generate a hypothesis-driven explanation theory based on comparing one or more features of the reference case to one or more features of the new case.

In aspects, the controller 200 may cause the system 100 to iteratively loop through steps 110, 112, 114, 106, and 108, leading to newly discovered knowledge 120, until all cases similar to the initially selected case are correctly predicted.

FIG. 5 shows an example of a Wigmorean probabilistic inference network used to assess a hypothesis based on evidence. The hypothesis H to be assessed may be decomposed into simpler hypotheses by considering both favoring arguments (supporting the truthfulness of H), under the left rectangle or square, and disfavoring arguments (supporting the falsehood of H), under the right rectangle or square. Each argument is an independent strategy of showing that H is true or false, and is characterized by a specific relevance or strength. The argument consists either of a single sub-hypothesis (e.g., H₃) or a conjunction of sub-hypotheses (e.g., H₁ and H₂). The sub-hypotheses from these arguments are further decomposed through other arguments, leading to simpler and simpler (sub-sub) hypotheses that can be more accurately assessed based on evidence. Evidence is any observable sign, datum, and/or item of information that is relevant in deciding whether a statement or hypothesis (e.g., a scientific claim) is true or false.

Consider, for example, sub-sub-hypothesis H_{2b}. There are two items of evidence relevant to this hypothesis, the favoring evidence item E₁, and the disfavoring evidence item E₂. Each item of evidence has three credentials that need to be assessed: accuracy, relevance, and inferential force. The accuracy of evidence answers the question: “What is the probability that the evidence is true?” The relevance of evidence to a hypothesis answers the question: “What would the probability of the hypothesis be if the evidence were true?” These two credentials are used to compute the inferential force or weight of the evidence on the hypothesis, which answers the question: “What is the probability of the hypothesis, based only on this evidence?” This is computed as the minimum between the accuracy and relevance. For example, the inferential force of E₁ is almost certain, that of E₂ is barely likely.

The probability of sub-sub-hypothesis H_{2b} is determined by balancing the inferential force of the favoring evidence with that of the disfavoring evidence. Once the probabilities of the bottom-level hypotheses have been computed based on evidence, the probabilities of the upper-level hypotheses are computed based on the logical structure of the Wigmorean probabilistic inference network (conjunctions and disjunctions of hypotheses), using min-max probability combination rules common to the Fuzzy probability view and the Baconian probability view. These rules are much simpler than the Bayes rule used in the Bayesian probability view or the Dempster-Shafer rule in the Belief Functions probability view.

In aspects, the Wigmorean probabilistic inference networks are learned by the intelligent software agent, such as a Knowledge Discovery Assistant (KDA) of the system 100 of FIG. 3.

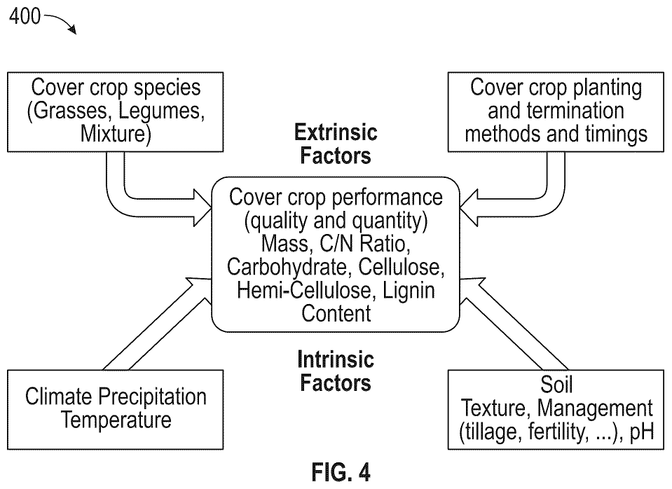

Thus, the specific Wigmorean probabilistic inference network for the example of biomass production of cover crops (FIGS. 6A and 6B) shows how the factors in FIG. 4 (e.g., climate, soil) supported the production of high biomass (top hypothesis) in the case of Maryland Farm1 during the 2018-2019 cover crop season. There are two arguments favoring the top hypothesis. The left argument, based on the current cover crop knowledge, consists of three sub-hypotheses and states that favorable environmental, management and genetic factors led to high biomass. Each of these factors has its own argument. For example, favorable environmental conditions were determined by favorable soil and climate conditions. Favorable soil conditions, in turn, were determined by high residual Nitrogen and excess drainage. These lower-level conditions are supported by actual evidence (that is, data from the case study), E1: Maryland Farm1 2018-19 has high residual N, and E2: Maryland Farm1 2018-19 has excess drainage. Now, following the inference steps from bottom-up, from these evidence items to the top hypothesis, one concludes high biomass on Maryland Farm1. The right argument of the top hypothesis is the direct evidence from the case data that the biomass produced was high, E7: Maryland Farm1 2018-19 has high biomass.

Thus, in this example, the argument based on knowledge correctly predicted the actual biomass produced. The question is: How can it be determined whether this is true for all the recorded cases? That is, how can it be determined whether, in all the recorded cases, the result predicted using the current cover crop knowledge is consistent with what was actually produced? Any discovered inconsistency is an indication of an imperfect Wigmorean prediction model and, thus, of imperfect knowledge. The system of FIG. 3 enables using these inconsistencies to correct or extend this knowledge.

Referring to FIGS. 6A and 6B, an example Wigmorean probabilistic inference network and the corresponding ontology fragment of the system of FIG. 1 is shown. Based on the argumentation from FIGS. 6A and 6B, an ontology is developed (see, e.g., the bottom right-hand side of FIGS. 6A and 6B) to represent the entities from the argumentation, as well as similar ones. The ontology contains concepts from the application domain, such as farm, plot, plant, and soil characteristic, which define the hierarchical types (taxonomies) for the entities in the argumentation. For example, Maryland Farm1 is a Maryland farm, which is a farm, while Plot1 is a plot. The ontology also represents the relationships between entities, for example, that Plot1 has high residual Nitrogen and excessive soil drainage. The KDA is taught to automatically generate argumentations like the one from FIGS. 6A and 6B based on farm data from other cases.

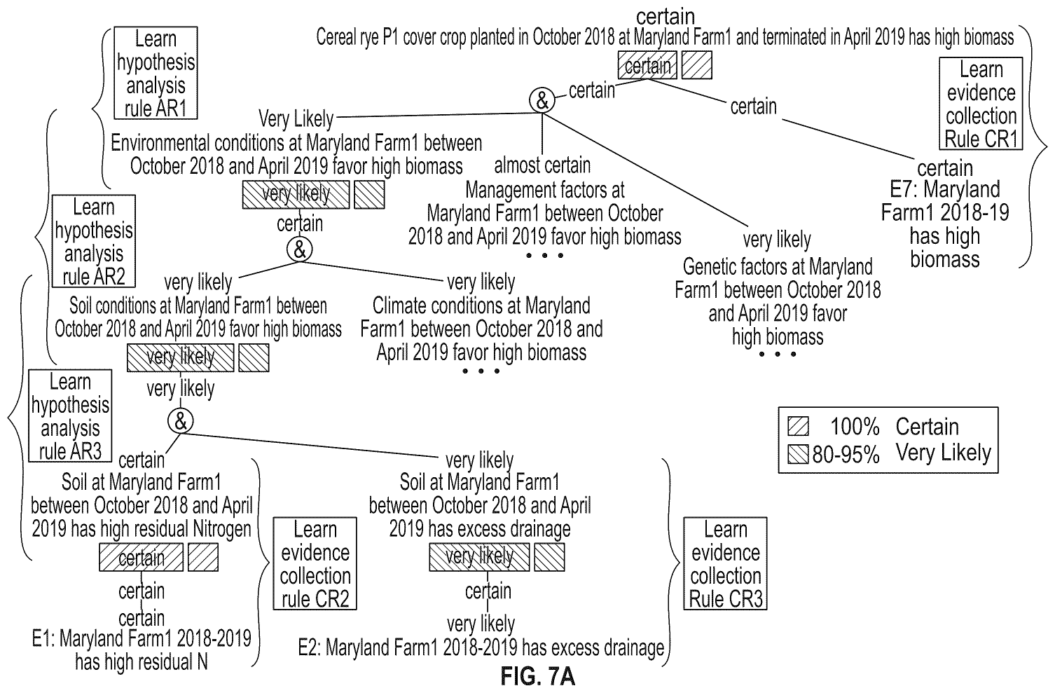

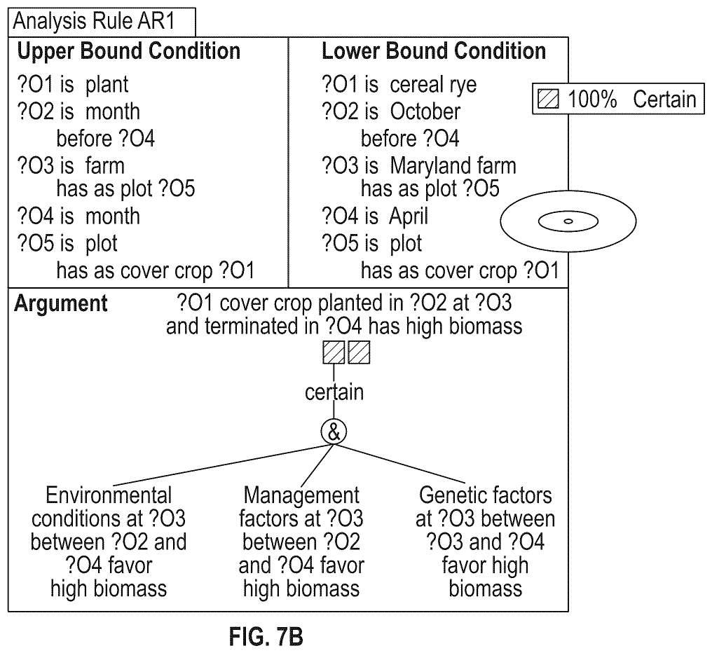

As illustrated in FIGS. 7A and 7B, the KDA learns a general hypothesis analysis rule from each specific argument that decomposes a hypothesis into sub-hypotheses. For example, from the top-left argument in FIGS. 7A and 7B, the KDA learns the hypothesis analysis rule A1 shown at the bottom right of that figure.

The learned rule consists of the argument pattern obtained by replacing the entities from the top-left argument in FIGS. 7A and 7B (cereal rye P1, October 2018, Maryland Farm1, April 2019) with corresponding variables (i.e., ?O1, ?O2, etc.). The rule also has an applicability condition that indicates the possible values of these variables for which the reasoning pattern is likely to be correct, based on the hierarchy of concepts from the ontology in FIGS. 6A and 6B. Notice, however, that instead of a single applicability condition, the KDA learns a lower bound and an upper bound for this condition using two complementary learning strategies.

The lower bound of the condition is generated by employing the strategy of a cautious learner that wants to minimize the chances of making mistakes when employing the learned pattern. This strategy increases the confidence of the KDA in the correctness of its reasoning. However, the KDA may fail to apply the reasoning pattern in situations where, in fact, it is applicable.

The upper bound of the condition is generated by employing the strategy of an aggressive learner that wants to maximize the opportunities of employing the learned pattern. This strategy increases the number of situations where the rule can be applied, although in some of these situations, the reasoning may not be correct.

The two bounds may be refined and may even become identical, based on additional example arguments encountered by the KDA.

The KDA also learns an evidence collection rule for each argument that reduces a hypothesis to an evidence item. A specialized collection agent can then search the data repository of recorded cases for the evidence item. The design and management of specialized collection agents are critical for the automatic extraction of evidence from existing farm data.

The vast majority of the current machine learning approaches rely heavily on statistics and learn single functions from a large number of examples. Such approaches are not applicable for the learning problem because sets of examples to learn from (i.e., arguments) do not exist and would require a significant effort to create. Instead, a user, such as an agricultural scientist, may explain to the KDA the individual arguments from FIGS. 6A and 6B by selecting the corresponding relations from the ontology or by defining them, and the agent learns rules as ontology-based generalizations of these arguments, as discussed above (FIGS. 7A and 7B). The explanations provided by the agricultural scientist to the KDA point directly to the relevant features of the individual arguments, enabling rapid learning. Thus, these features do not need to be discovered through the statistical comparison of a large number of positive and negative argument examples (that are often not available), as current (statistics-based) inductive learning methods do. The disclosed technology provides a technical solution to the problems from which the current inductive learning suffers.

Referring again to FIG. 3, at step 108, the controller 200 causes the system 100 to perform a knowledge-based search and classification. The generalized argumentation is automatically applied to cases that are similar to the reference farm case F_{ref}. The cases are split into favoring cases (high biomass) and disfavoring cases (low or medium biomass).

At step 110 the controller 200 causes the system 100 to select the most similar disfavoring case. In the case where there are disfavoring cases, the argumentation from FIGS. 7A and 7B is incomplete and/or partially incorrect. What factors were not taken into account have to be discovered and used to improve this argumentation. To facilitate this complex knowledge discovery process, the KDA selects a new case (Fₛ) from the set of disfavoring ones that are most similar to the reference farm case F_{ref} (i.e., Maryland Farm1). Since there will be very few factors that are different, some may be responsible for the difference in cover crop biomass. This farm case Fₛ might be, for example, Virginia Farm3 during the 2017-2018 cover crop season. The corresponding Wigmorean argumentation generated by KDA through the instantiation of the learned rules from FIGS. 7A and 7B is shown in FIG. 8. Notice that, in this case, the direct evidence E37 disfavors the top hypothesis because the actual cover crop biomass produced was medium.

At step 112, the controller 200 causes the system 100 to perform a hypothesis-driven explanation discovery. The system 100 generates a hypothesis of an explanation for the difference in cover crop biomass between the two very similar cases F_{ref} (Maryland Farm1) and Fₛ (Virginia Farm3). After comparing data from these two farms, the system 100 generates a hypothesis that the cause of medium biomass at Virginia Farm3 is the soil pH during the 2017-2018 season, which is too low. For example, since the soil pH at the Maryland Farm1 during the 2018-2019 season was neutral, the agricultural scientist hypothesizes that an additional relevant soil condition for high biomass (besides high residual Nitrogen and excessive drainage shown in FIGS. 6A and 6B) is neutral pH.

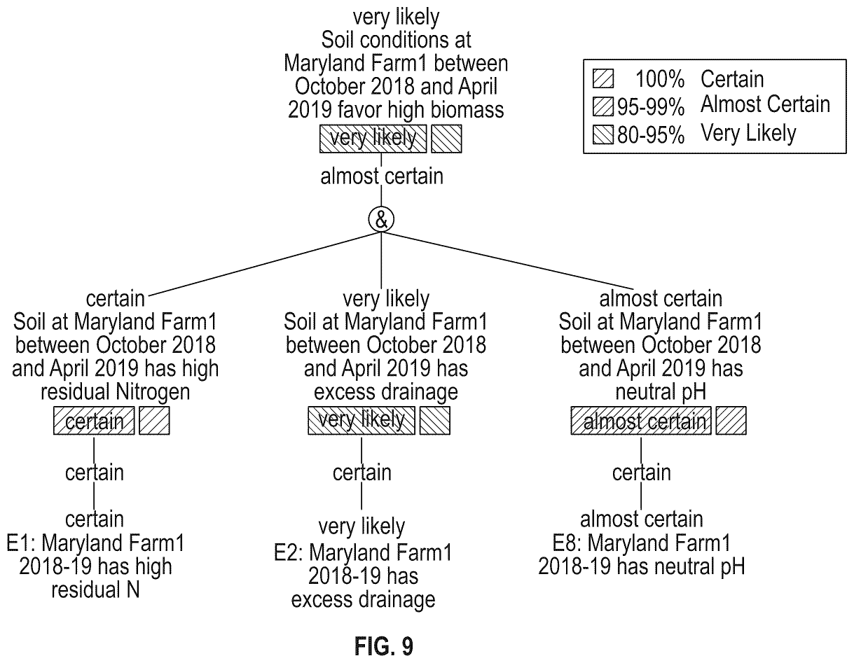

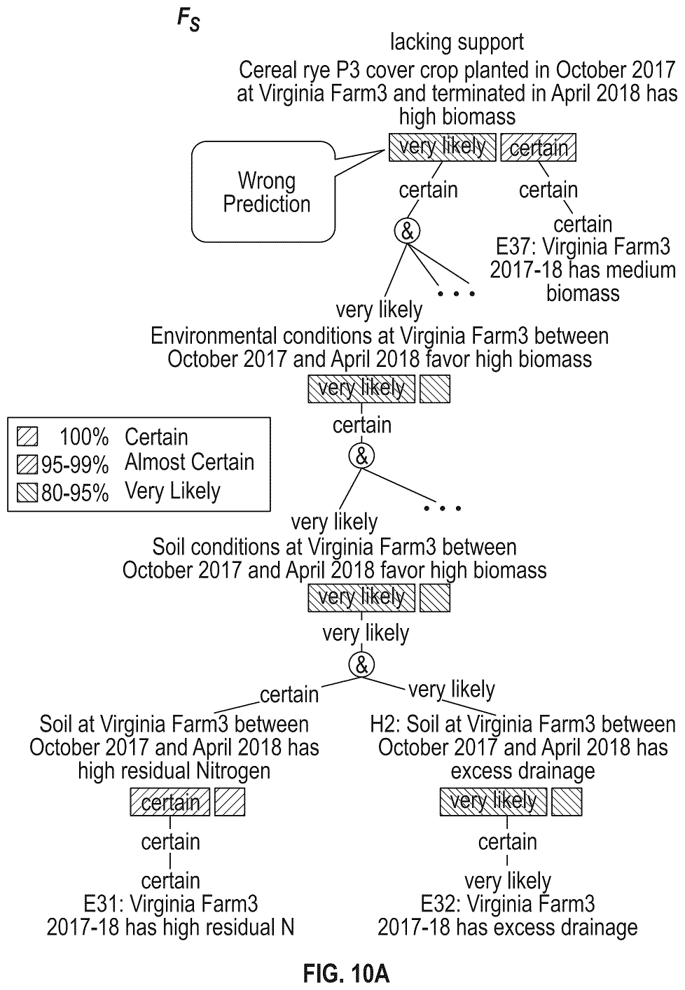

At step 114, the controller 200 causes the system 100 to perform explanation-based refinement of the argumentation. As a result, the argumentation from FIGS. 6A and 6B inferring high biomass for the reference case F_{ref} is extended (FIG. 9) with the additional soil pH condition generalized as illustrated in step 106, validated on Virginia Farm3 during the 2017-2018 season, and automatically applied to all similar cases in step 108. If the total number of favoring cases is not increased (or, equivalently, the total number of disfavoring cases not decreased), the hypothesis formulated in step 112 is rejected and a new explanation has to be hypothesized. If, however, the total number of favoring cases is increased, the hypothesis is accepted and represents newly discovered knowledge 120.

The loop of steps 106, 108, 110, 112, and 114 (FIG. 1) is repeated, leading to new discovered knowledge 120, until all cases similar to F_{ref} are correctly predicted, with the possible exception of a few anomalous cases. The result of this process is the discovery of new knowledge and a generalized argumentation that correctly infers and explains cover crop biomass for the class of cases similar to F_{ref}.

Then, the process restarts with step 102 (FIG. 1), in which a new reference farm case is selected from the remaining data (if any). The entire process is repeated along the steps from FIG. 1, until all available farm cases are correctly predicted, with the possible exception of a few anomalous cases (including those for which the data may be incorrect or incomplete).

The disclosed technology may be used by agricultural scientists to discover knowledge in three areas, one being the biomass accumulation of cover crops discussed above.

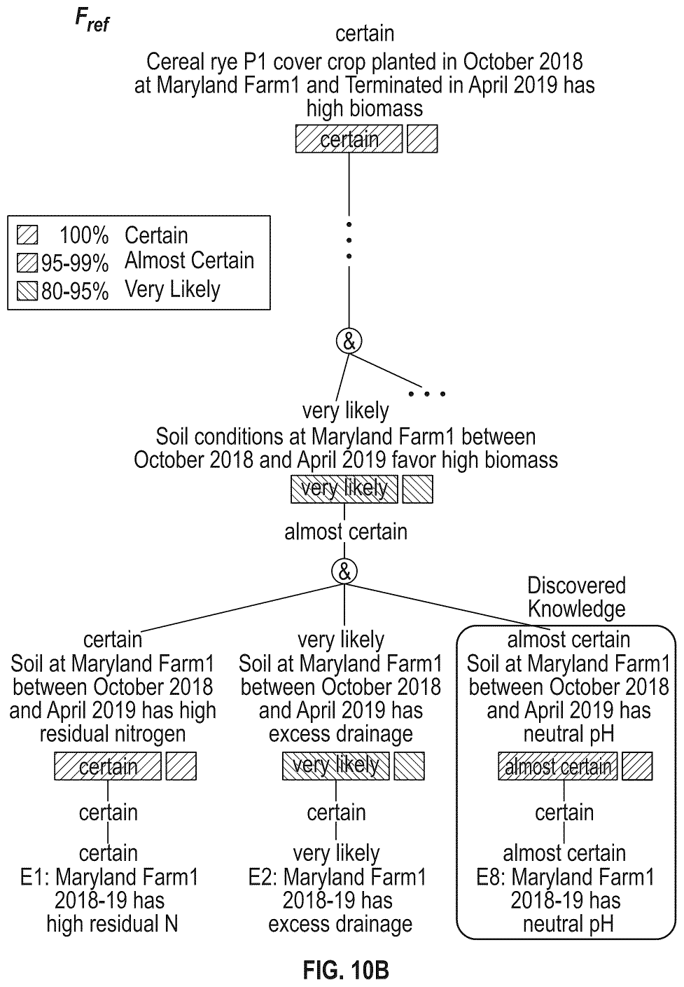

Referring to FIGS. 10A and 10B, a diagram illustrating example argumentation generated by the system of FIG. 1 that is inconsistent with example evidence (left) and the refined argument generated by the system of FIG. 1 (right), is shown.

Since there are disfavoring cases, the argumentation from FIGS. 6 and/or 7 is incomplete and/or partially incorrect. The system has to discover what factors were not taken into account and improve this argumentation. To facilitate this complex knowledge discovery process, the KDA selects a new case Fₛ from the set of disfavoring ones that is most similar to the reference farm case F_{ref} (i.e., Maryland Farm1). Since there will be very few factors that are different, some may be responsible for the difference in cover crop biomass. This farm case Fₛ might be, for example, Virginia Farm3 during the 2017-2018 cover crop season. The corresponding instantiation of the generalized argumentation from FIGS. 6A and 6B is shown in FIG. 10A. Notice that, in this case, the direct evidence E37 disfavors the top hypothesis because the actual cover crop biomass produced was medium.

As a result, the argumentation from FIGS. 6A and 6B inferring high biomass for the reference case F_{ref} is extended (FIGS. 10A and 10B) with the additional soil pH condition generalized as discussed in step 106 (FIG. 1), validated on Virginia Farm3 during the 2017-2018 season, and automatically applied to all similar cases in step 108 (FIG. 1). If the total number of favoring cases is not increased (or, equivalently, the total number of disfavoring cases not decreased), the hypothesis formulated in step 112 (FIG. 1) is rejected and a new explanation must be hypothesized. If, however, the total number of favoring cases is increased, the hypothesis is accepted and represents newly discovered knowledge 120.

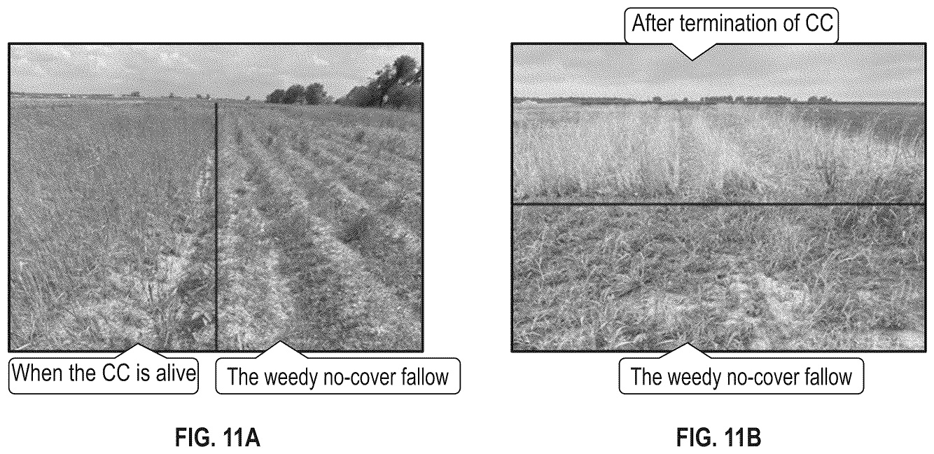

Referring to FIGS. 11A and 11B, an example comparison of cover crop application in a field before and after termination is shown. Weed suppression by a grass cover crop compared to no cover crop when the cover is alive (FIG. 11A) and after termination (FIG. 11B). The weedy no-cover fallow is shown in the right (FIG. 11A) and bottom (FIG. 11B). Cover crops outcompete weeds for resources while living, thus dominating the field and preventing weeds from growing. Once terminated, they provide physical and chemical suppression which lowers weed germination, growth, and development, and reduces weed vigor and competition with cash crops. Terminated cover crop mulches suppress weeds physically by impeding emergence or attenuating environmental cues that otherwise break weed seed dormancy (i.e., light and temperature), by releasing phytotoxic compounds (i.e., allelopathy), and/or bio-geochemically by immobilizing soil nitrogen (another weed seed germination cue) in the case of high carbon/nitrogen (C:N) ratio grass cover crop mulches.

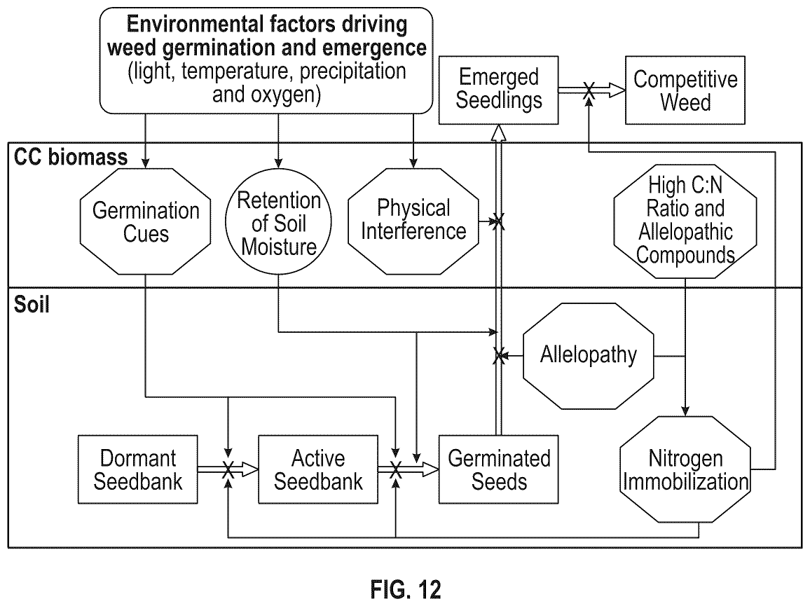

Referring to FIG. 12, a diagram illustrating the causal relationships between different factors and the germination, emergence, and growth of weeds, is shown. Cover crops are clearly not a one-size-fits-all weed control tool because cover crop effects on weeds are highly variable across environments. Farms differ in climate, soil, and management practices, all of which have been identified as primary factors influencing cover crop performance and subsequent impact on weed suppression. However, there is a severely limited understanding of how climate, soil, and weed density interact with cover crop performance (biomass production and C:N ratio) and their subsequent impact on weed suppression.

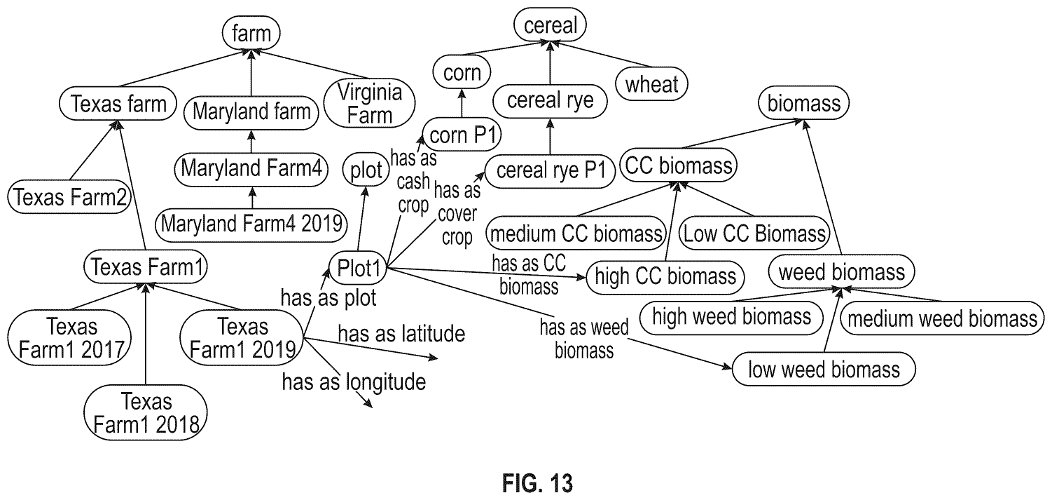

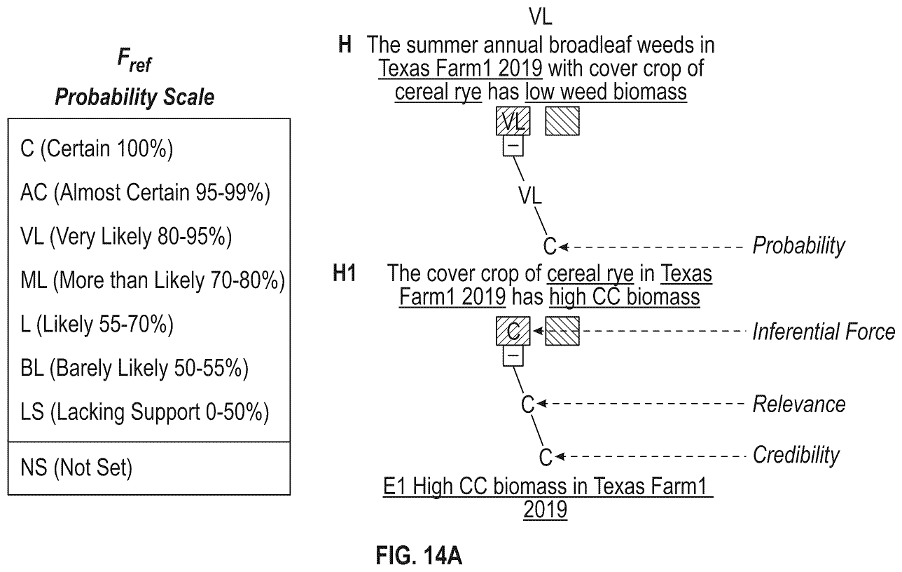

Referring to FIG. 13, a diagram illustrating an example ontological representation of the system of FIG. 1, is shown. As shown in FIG. 1, the first step of the investigation and knowledge discovery process is to select a reference farm case F_{ref} that will guide the uncovering of knowledge applicable to the class of cases similar to it. In this illustration, F_{ref} is the specific summer annual weed biomass experience on the reference farm case, Texas Farm1 in 2019. Low biomass of summer annual broadleaf weeds was attributed to a cereal rye cover crop. The description of F_{ref} may consist of all the characteristics of F_{ref} that may potentially relate to the resultant low biomass of summer annual broadleaf weeds, including light, temperature, precipitation, oxygen, soil moisture, soil N, C:N ratio of the residue, and allelopathic potential. Its ontological representation is illustrated in FIG. 13. Notice that Texas Farm1 2019 had Plot1 planted with corn following a cereal rye F_{ref} with high F_{ref} biomass. It had low weed biomass of summer annual broadleaf weeds. As discussed later, the ontology plays a major role in the approach as the generalization hierarchy for learning.

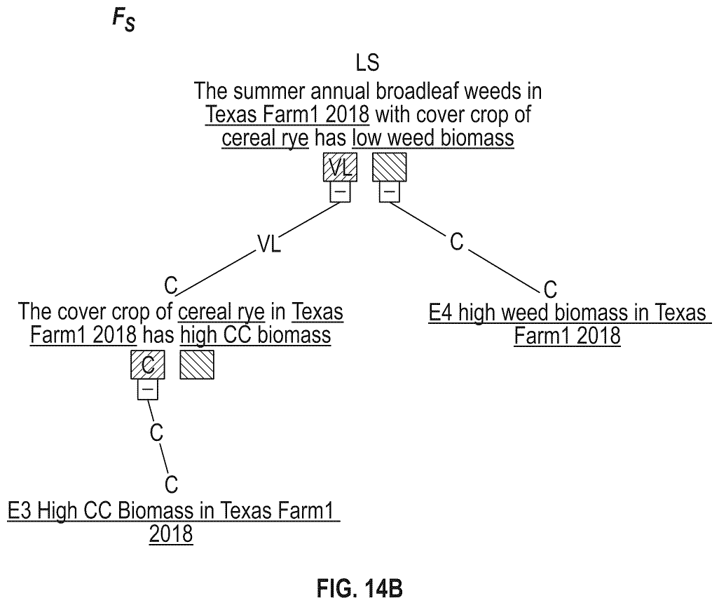

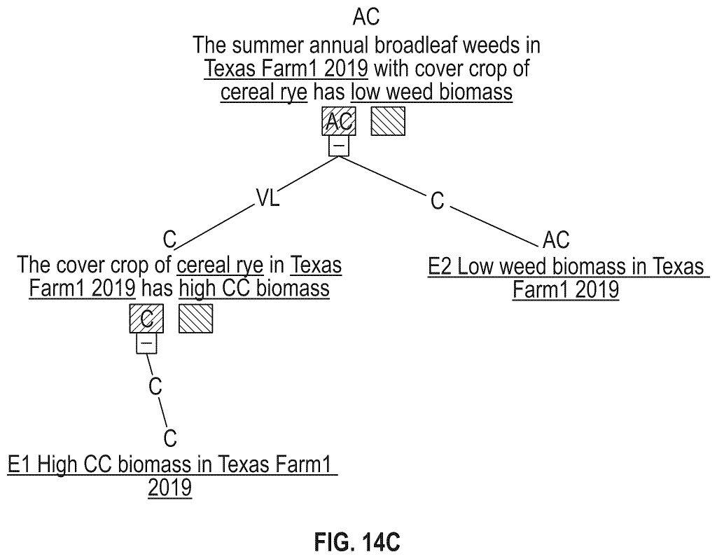

Referring to FIG. 14A, an example illustrating an example Wigmorean probabilistic inference network and probability scale for a specific example farm, is shown. FIG. 14B shows the example Wigmorean probabilistic inference network for the prior year of the farm of FIG. 14A. FIG. 14C shows an example illustrating a refinement of the Wigmorean probabilistic inference network of FIG. 14A.

In step 104 (FIG. 1), the current understanding of the factors influencing weed growth is used to explain the resulting low weed biomass on Texas Farm1 in 2019. Wigmorean probabilistic inference networks are used to represent such explanations using the Cogent cognitive assistant. FIG. 14A, for example, shows a simple Wigmorean probabilistic inference network that explains the resultant low weed biomass on Texas Farm1 in 2019. It shows how the evidence E1 of high cover crop biomass on Texas Farm1 in 2019 favors the hypothesis H1 (The cover crop of cereal rye in Texas Farm1 2019 has high cover crop biomass), and how H1 favors the main hypothesis H (The summer annual broadleaf weeds in Texas Farm1 2019 with cover crop of cereal rye have low weed biomass).

First, one directly assesses the probability of hypothesis H1 based on the item of evidence E1 by assessing the three credentials of evidence: credibility, relevance, and inferential force, as shown in FIG. 14A. The credibility of evidence answers the question: What is the probability that the evidence is true? As shown in the left-hand side of FIG. 14A, Cogent employs a system of symbolic probabilities with Fuzzy qualifiers, such as BL (barely likely, 50 to 55% probability of being true), VL (very likely, 80 to 95% true) or C (certain, 100%). In this case the credibility of E1 was assessed as C (certain) because cover crop biomass was reliably measured as high (over 5,000 kg ha⁻¹). The relevance of evidence to a hypothesis answers the question: What would be the probability of the hypothesis if the evidence were true? In this case, if E1 is true then H1 is true, and therefore the relevance of E1 is C (certain). The inferential force or weight of the evidence on the hypothesis answers the question: What is the probability of the hypothesis, based only on this evidence? Obviously, an irrelevant item of evidence will have no inferential force and will not convince us that the hypothesis is true. An item of evidence that is not credible will have no inferential force either. Only an item of evidence that is both relevant and credible may convince us that the hypothesis is true. Consistent with both the Baconian and the Fuzzy min/max probability combination rules, the inferential force of an item of evidence on a hypothesis is determined as the minimum between its credibility and its relevance which, in this illustration, is C (certain). Because in the situation from FIG. 14A there is only one item of favoring evidence, the inferential force of the situation from FIG. 14A on the hypothesis is also the probability of the hypothesis. In general, however, the probability of the hypothesis would be the result of the balance of probabilities between the combined inferential force (maximum) of the favoring evidence items (under the left green square) and the combined inferential force of the disfavoring items (represented under the right pink square). The probability of the main hypothesis H is assessed in a similar way as VL (very likely), based on the probability of its sub-hypothesis H1 © and the relevance (VL) of H1 to H. Thus, H1 represents a favoring argument for the truthfulness of H. Another favoring argument is represented by the direct evidence E2 (the actual measurement of the weed biomass), as shown in FIG. 14C. Therefore, for the reference farm, Texas Farm1 in 2019, the explanation is consistent with the direct evidence.

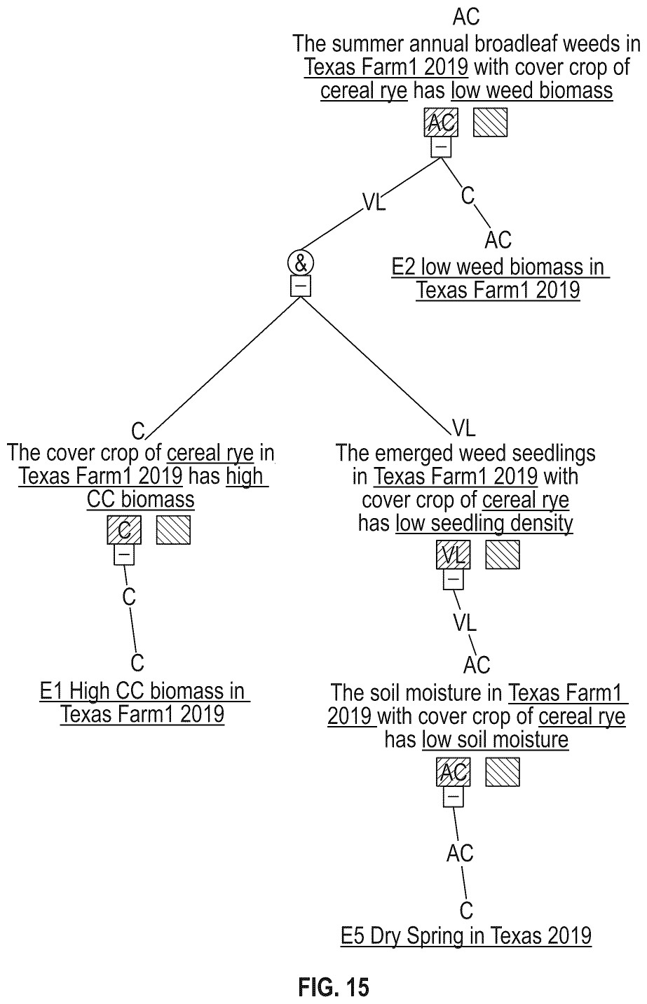

Referring to FIG. 15, an example illustrating an explanation-based refinement of a Wigmorean probabilistic inference network is shown. Based on the discovered explanation (Spring moisture) the argumentation in FIG. 14C is refined as shown in FIG. 15, generalized as discussed in step 106 (FIG. 1), and automatically applied to all similar cases in step 108 (FIG. 1). If the total number of favoring cases is not increased (or, equivalently, the total number of disfavoring cases not decreased), the explanation formulated in step 112 (FIG. 1) is rejected and the system 100 has to hypothesize a new explanation. If, however, the total number of favoring cases is increased, the explanation is accepted and represents newly discovered knowledge 120.

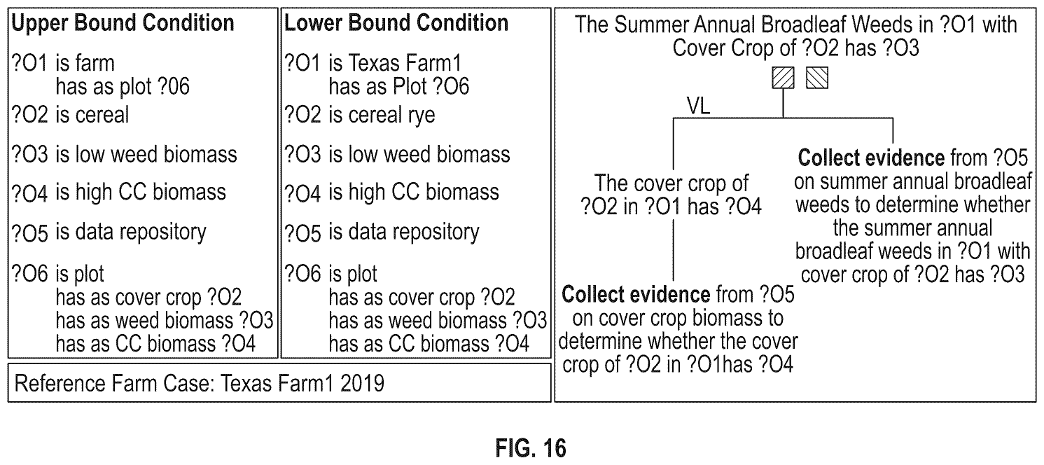

Referring to FIG. 16, an example description of a Wigmorean probabilistic inference network, is shown. The controller 200 causes the system 100 to determine to what extent the developed argumentation shown in FIG. 14A also explains weed biomass produced in other cases similar to that of F_{ref}. This involves a process of knowledge-based learning and evidence-based reasoning where the specific argumentation is automatically generalized to an argumentation pattern and an associated applicability condition, shown in FIG. 16. For example, the specific argumentation in FIG. 14C will be generalized to the argumentation pattern from the right-hand side of FIG. 16 by: replacing each instance (e.g., Texas Farm1 2019) with a variable (i.e., ?O1); or replacing each evidence item (e.g., E1 High cover crop biomass in Texas Farm1 2019) with an evidence collection request. This evidence collection request will call a specialized collection agent that will automatically search the Case Data Base for the evidence specified in an instantiated request.

The existence of disfavoring cases shows that the argumentation from FIG. 14A is incomplete or partially incorrect. The system 100 discovers what factors were not taken into account and improves this argumentation. To facilitate this complex knowledge discovery process, a new case Fₛ is selected from the set of disfavoring ones that is most similar to the reference farm case F_{ref} (i.e., Texas Farm1 2019) because there will be very few factors that are different, some of which are responsible for the difference in weed biomass. This farm case Fₛ might be, for example, the cover crop experience on the same Texas farm in the previous year (i.e., Texas Farm1 2018). The corresponding instantiation of the generalized argumentation from FIG. 16 is shown in FIG. 14B. Notice that, in this case, the direct evidence E4 disfavors the top hypothesis because the actual weed biomass produced was high.

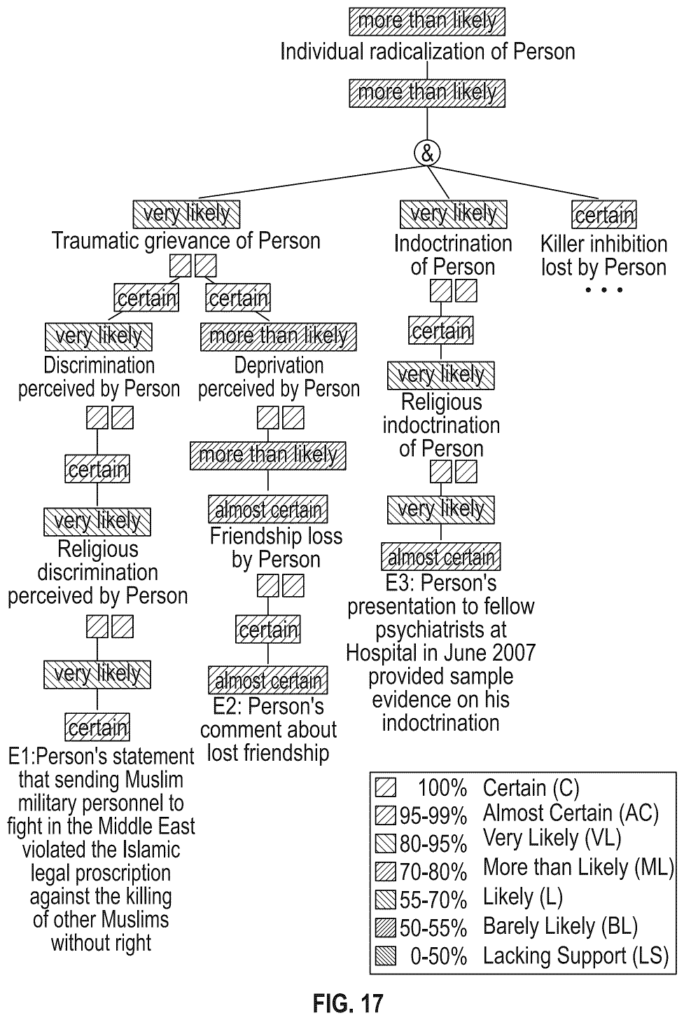

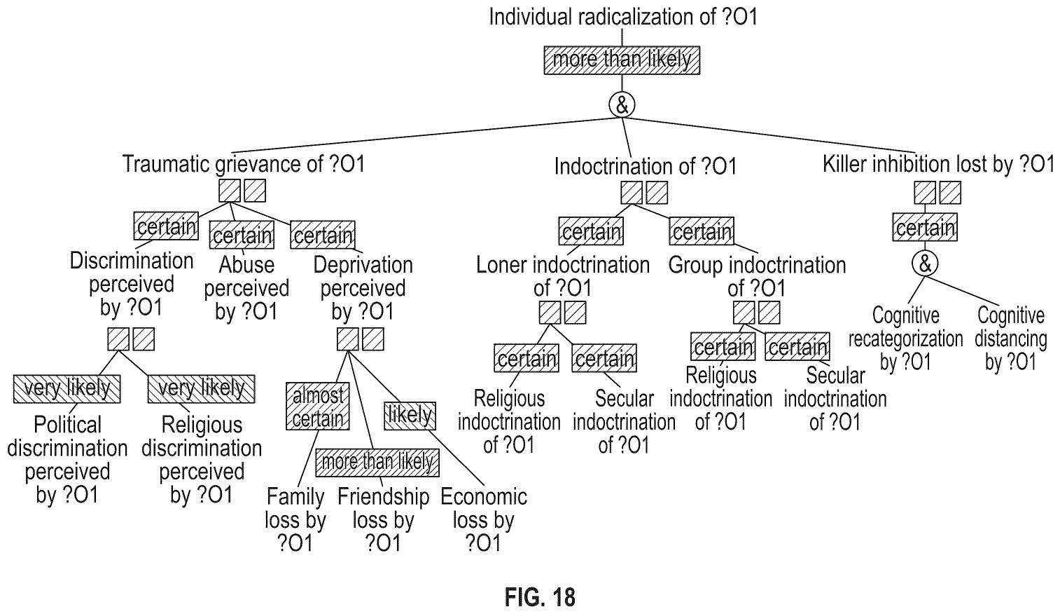

Referring to FIGS. 17 and 18, the system of FIGS. 1 and 3 may be used to predict behavior, such as in the following example. Step 1: Selection of a reference case I_{ref}. As shown in FIG. 3, a reference individual case is selected for which actual data exist: The radicalization of an example Person who, on Nov. 5, 2009, entered the deployment center at a military base, and killed several DOD employees and wounded others.

Step 2: Development of Argumentation that Explains the Behavior on I_{ref}. The current knowledge on Behaviors, Values and Motivations is used to develop a predictive model (in the form of a Wigmorean argumentation) that explains how the values and motivations of Person of the reference case led to his indoctrination.

Step 3: Knowledge-Based Generalization of the Argumentation. Generalize the Wigmorean argumentation into a general predictive model that can be applied to other individuals as well.

Step 4: Automatic Discovery of Favoring and Disfavoring Cases. This step involves a process of knowledge-based search and classification. The generalized argumentation is automatically applied to cases that are similar to the reference case I_{ref} Then these cases are split into favoring cases (radicalization occurred) and disfavoring cases (radicalization did not occur).

Step 5: Selection of the Most Similar Disfavoring Case. A disfavoring case shows that the argumentation from FIG. 17 is incomplete and/or partially incorrect. It is thus necessary to discover what factors were not taken into account, and improve this argumentation. To facilitate this complex knowledge discovery process, a new case Iₛ is selected from the set of disfavoring ones that is most similar to the reference case I_{ref} (i.e., Major Hasan). Since there will be very few factors that are different, it should be easier to discover which of them is responsible for the difference in the radicalization result.

Step 6: Hypothesis-Driven Explanation Discovery. Now one has to iteratively hypothesize each difference as being the explanation for the difference in the radicalization result between the two very similar cases I_{ref} (Person) and Iₛ.

Step 7: Explanation-Based Refinement of the Argumentation. The argumentation from FIG. 17 inferring radicalization for the reference case I_{ref} is refined based on the current explanation and automatically applied to all similar cases in Step 4. If the total number of favoring cases is not increased (or the total number of disfavoring cases not decreased), the hypothesis formulated in Step 6 is rejected and a new explanation has to be hypothesized. Otherwise, the hypothesis is accepted and represents discovered knowledge.

Loop 5-6-7-3-4: Learning Argumentation-Based Explanation Models. This loop (FIG. 3) is repeated until all cases similar to I_{ref} are correctly predicted, with the possible exception of a few anomalous cases. The result of this process is the discovery of new knowledge and a generalized argumentation that correctly predicts and explains radicalization for the class of cases similar to I_{ref}. Then, the process restarts with Step 1, in which a new reference case is selected from the remaining data (if any). The entire process is repeated along the steps from FIG. 2 as discussed so far, until all available cases are correctly predicted, with the possible exception of a few anomalous cases (e.g., those for which the data may be incorrect or incomplete).

For example, the system 100 may be used to determine the impacts to national security. Once learned, the predictive models can be used in several ways, as illustrated below with the model of individual radicalization from FIG. 18. For example, the model can be used to educate intelligence, homeland defense, and military personnel on politico-religious extremism and individual radicalization that pose very high threats to national security.

The system 100 may be used to recognize potential cases of radicalization, early enough to take corresponding actions. In aspects, system 100 can be used to develop the following mitigation strategies: Preventing grievances by opposing discrimination, either as oppressive or political; preventing abuse in its many forms; and healing deprivation by strengthening family and kin-based associations, fostering communities that promote friendship, promoting economic development, validating social acceptance and community-based status regardless of rank. Avoiding collateral damage should be considered as part of the counter-terrorism policy evaluation: collateral damage is a potential cause of radicalization in counter-terrorism campaigns. Preventing indoctrination into an extremist belief system (EBS) by identifying loners that might become potential terrorists, especially those that already have military training; monitoring and when necessary enforcing laws against groups that can provide indoctrination into EBS. Promoting moral development among infants and adolescents to strengthen their inhibitions against killing. Both secular and religious belief systems can and should be invoked for this purpose. Specifically, communicate the known pathological consequences of categorization and distancing when combined as a mechanism for overcoming killing inhibition.

The aspects disclosed herein are examples of the disclosure and may be embodied in various forms. For instance, although certain aspects herein are described as separate aspects, each of the aspects herein may be combined with one or more of the other aspects herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an aspect,” “in aspects,” “in various aspects,” “in some aspects,” or “in other aspects” may each refer to one or more of the same or different aspects in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

Any of the herein described methods, programs, algorithms, or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, scripting languages, Visual Basic, metalanguages which themselves specify programs, and all first, second, third, fourth, fifth, or further generation computer languages. Also included are database and other data schemas, and any other meta-languages. No distinction is made between languages that are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

It should be understood the foregoing description is only illustrative of the present disclosure. Various alternatives and modifications can be devised by those skilled in the art without departing from the disclosure. Accordingly, the present disclosure is intended to embrace all such alternatives, modifications, and variances. The embodiments described with reference to the attached drawing figures are presented only to demonstrate certain examples of the disclosure. Other elements, steps, methods, and techniques that are insubstantially different from those described above are also intended to be within the scope of the disclosure.

What is claimed is:

1. A system for knowledge discovery comprising:
a processor; and
a memory coupled to the processor and storing instructions which, when executed by the processor, cause the system to:
access a reference case of a plurality of cases;
generate argumentation that explains a phenomenon of the reference case by developing a predictive model;
generate a knowledge-based generalization of the argumentation by learning a lower bound generalization and an upper bound generalization;
apply the argumentation to a plurality of cases similar to the reference case based on knowledge-based search and classification;
split the plurality of similar cases into a plurality of favoring cases and a plurality of disfavoring cases;
select a disfavoring case of the plurality of disfavoring cases that is most similar to the reference case based on a similarity of factors;
determine what factors were not taken into account in generating the argumentation; and
generate a hypothesis-driven explanation theory based on comparing one or more features of the reference case to one or more features of the most disfavoring case.

2. The system of claim 1, wherein when generating a knowledge-based generalization of the argumentation, the instructions, when executed by the processor, further cause the system to:
learn an evidence collection rule for each argument that reduces the hypothesis to an evidence item; and
search the plurality of reference cases, by a collection agent, for the evidence item.

3. The system of claim 1, wherein the predictive model includes a probabilistic inference network.

4. The system of claim 1, wherein the predictive model includes a Wigmorean probabilistic inference network.

5. The system of claim 1, wherein the argumentation includes at least one of a hypothesis or a conjunction of sub hypothesis.

6. The system of claim 1, wherein the hypothesis to be assessed is decomposed into simpler hypotheses by considering both favoring arguments and disfavoring arguments.

7. The system of claim 6, wherein the lower bound employs a cautious learner strategy and wherein the upper bound employs an aggressive learning strategy.

8. The system of claim 1, wherein the disfavoring case provides an indication that the generated argumentation is incomplete and/or partially incorrect.

9. The system of claim 1, wherein the instructions, when executed by the processor, further cause the system to:
refine the generated hypothesis-driven explanation theory based on selecting a new case from the plurality of disfavoring cases that is most similar to the reference case.

10. A system for determining cover crop biomass comprising:
a processor; and
a memory coupled to the processor and storing instructions which, when executed by the processor, cause the system to:
select a reference farm case of a plurality of reference farm cases;
access partial knowledge related to a phenomenon of the reference farm case;
access imperfect data related to the phenomenon of the reference farm case;
generate a predictive model based on the partial knowledge and imperfect data;
predict a result related to the phenomenon of the reference farm case based on one or more features of the reference farm case;
access actual results related to the phenomenon of the reference farm case; and
generate a hypothesis-driven explanation theory that explains the phenomenon based on comparing the predicted result to the actual result.

11. The system of claim 10, wherein the predictive model includes a Wigmorean probabilistic inference network.

12. A computer-implemented method for knowledge discovery comprising:
selecting a reference case of a plurality of reference cases;
generating argumentation that explains a phenomenon of the reference case by developing a predictive model;
generating a knowledge-based generalization of the argumentation by learning a lower bound and an upper bound;
applying the argumentation to a plurality of similar cases that to the reference case based on knowledge-based search and classification;
splitting the plurality of similar cases into a plurality of favoring cases and a plurality of disfavoring cases;
selecting a most disfavoring case of the plurality of disfavoring cases based on a similarity of factors to the most disfavoring case;
determining what factors were not taken into account in generating the argumentation; and
generating a hypothesis-driven explanation theory based on comparing one or more features of the reference case to one or more features of the most disfavoring case.

13. The computer-implemented method of claim 12, wherein when generating a knowledge-based generalization of the argumentation, the method further comprises:
learning an evidence collection rule for each argument that reduces the hypothesis to an evidence item; and
searching the plurality of reference cases, by a collection agent, for the evidence item.

14. The computer-implemented method of claim 12, wherein the predictive model includes a Wigmorean probabilistic inference network.

15. The computer-implemented method of claim 12, wherein the argumentation includes at least one of a hypothesis or a conjunction of sub hypothesis.

16. The computer-implemented method of claim 12, wherein the hypothesis to be assessed is decomposed into simpler hypotheses by considering both favoring arguments and disfavoring arguments.

17. The computer-implemented method of claim 16, wherein the lower bound employs a cautious learner strategy and wherein the upper bound employs an aggressive learning strategy.

18. The computer-implemented method of claim 12, wherein the disfavoring case provides an indication that the generated argumentation is incomplete and/or partially incorrect.

19. The computer-implemented method of claim 12, further comprising refining the generated hypothesis-driven explanation theory based on selecting a new case from the plurality of disfavoring cases that is most similar to the reference case.

20. The computer-implemented method of claim 12, wherein the predictive model includes probabilistic inference network.
